(19) United States
(12) Patent Application Publication
(10) Pub. No.: US 2018/0204133 A1
(43) Pub. Date: Jul. 19, 2018

(54) DEMOGRAPHIC PREDICTION FOR USERS IN AN ONLINE SYSTEM WITH UNIDIRECTIONAL CONNECTION

(71) Applicant: Facebook, Inc., Menlo Park, CA (US)

(72) Inventors: Chaochao Cai, Bellevue, WA (US); Goran Predovic, Redmond, WA (US)

(21) Appl. No.: 15/409,374

(22) Filed: Jan. 18, 2017

(51) Int. Cl. G06N 99/00; G06F 17/30; H04L 29/08

(52) U.S. Cl. CPC G06N 99/005; H04L 67/306; H04L 67/18; G06F 17/30424

(57) ABSTRACT

Disclosed is a content sharing system that infers demographic attributes of users of the content sharing system based on features of the users with accounts matched to an online system with known demographic attributes. The features include attributes of unidirectional connections of the users on the content sharing system. In some embodiments, the features are distributions of demographic attributes of the unidirectional connections of the users, such as distributions of ages or genders of the unidirectional connections. The content sharing system provides the features as input to a classifier trained to predict a particular demographic attribute value and the classifier outputs a predicted value of that demographic attribute. In some embodiments, the content sharing system trains a classifier for various demographic attributes by forming training sets for the demographic attributes using the features for users.

### FIELD OF ART

The present disclosure generally relates to the field of machine learning, and more specifically, to predicting attributes of users of an online system for whom limited information is otherwise available.

### BACKGROUND

Online systems often need to choose content to be distributed to users. This becomes more difficult when attributes of the users are unknown to the online systems, since the online systems will then have little or no information on which to draw when identifying the most appropriate content for the users. Unfortunately, this is often the case, such as when those particular attributes are not tracked by the online system, or (if tracked) the online system does not have a value for the attributes for the users in question. Accordingly, in such situations, the online systems are unable to determine the most appropriate content to distribute to such users, possibly resulting in those users being included in audiences for content that is not as relevant to those users due to this lack of data about the users' interests and demographic profiles.

### SUMMARY

An online system uses machine learning-based prediction of attributes of users of the online system for whom the attributes are not known on the online system, e.g., to determine the most appropriate content to distribute to such users. Without knowledge of whether the users have the attributes in question, the online system cannot determine whether the users should be included within audiences defined in terms of those attributes. As one example, a content provider might define an audience for the content provider's content to be distributed on the online system as all females between ages 18 and 20. But if the online system does not track user gender (or does not know the genders of particular users), the online system may not have enough data about the user to determine if the users meets the defined audience for the content.

According to some examples, the online system predicts the attributes of users for whom the attributes are not known in a series of steps using information available about those users. The online system receives from content providers a set of content items associated with an audience defining demographic attributes of users for display to users of the online system. The online system derives features for a user (e.g. distribution of demographic information of users with unidirectional associations with the user) based on information about the user, where a value of one or more demographic attributes is not known for the user). The demographic attributes to be determined may include, as one example, the age of the user, the gender of the user, and/or the location of the user (e.g., Santa Clara County). For each of the demographic attributes, the online system forms a training set of users for the demographic attribute. The online system trains a classifier to predict the demographic attribute for a user based on features of users of the training set as input to a machine learning algorithm. When the online system detects an opportunity to provide one of the received content items from the content providers to a user whose demographic attribute values are not known, the online system applies one or more of the trained classifiers to predict demographic attributes for the user by performing a set of steps. The online system derives the features based on attributes of users who are unidirectional connections of the user on the online system. The online system provides the features as input to one of the trained classifiers derived from machine learning. The online system obtains as an output from the trained classifier a prediction of a value for at least one of the demographic attributes of the user (e.g., that the user is age 28, or in the age range 25-28). The online system selects content to provide for display to the user based on the predicted values of the demographic attributes of the user.

The online system derives a set of features of users visiting the online system by determining attributes of other users with unidirectional following relationships (e.g., followed by the user, or following the user) on the online system. For instance, the set of features may include: one or more distributions of attributes (e.g., an age, a gender, and a geographic location) of the users. If the attributes are not tracked by the online system itself, then the online system may perform matches of profiles of the users on the online system with profiles of the users on a second online system that does track the attributes.

The online system then trains a classifier or machine learning model to determine values of the demographic attribute (e.g. female gender) for users based on the user profiles on the online system. The online system forms a training set of the known users for the demographic attribute based on the determined values (e.g., a “female” training set of users known based on their profiles to have the “female” value of the “gender” demographic attribute). The online system trains a classifier for the demographic attribute by providing the features of known users of the training set as input to a supervised machine learning algorithm such that the algorithm learns what features are commonly associated with that demographic attribute.

In one example, when a first online system detects an opportunity to provide one of the received content items to a user for whom the demographic attributes are not known to the first online system, the first online system derives a set of features associated with the user based on matching with a second online system (such as matching user profiles of unidirectionally-connected users to corresponding profiles on a second online system).

When a user of the first online system, for whom the first online system lacks information for certain demographic attribute, uses the first online system, the first online system applies the trained classifier to infer the missing demographic attributes. To do so, the first online system derives the same type of features derived as part of the training process (e.g., distributions of demographic attributes of users with a unidirectional relationship to the user, as determined by matching with the users' profiles on a second online system). The first online system provides the derived features as input to the trained classifier. The first online system obtains as an output from the trained classifier a prediction of a value for at least one of the demographic attributes of the user (e.g., a prediction that the user is female and in the age ranges 18-20). The first online system selects content to provide to the user of the first online system based on the predicted value of the demographic attribute (e.g., whether the user is female) and provides the selected content to the user of the first online system.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

FIG. 1 illustrates a computing environment in which users use their client devices to interact with a content sharing system, according to one embodiment.

FIG. 2 is a high-level block diagram illustrating a detailed view of a content sharing system for inferring demographic attributes of users, according to one embodiment.

FIG. 3 is a flowchart illustrating the selection of content to provide to the user based on inferred demographic attributes, according to one embodiment.

FIG. 4 is a high-level block diagram illustrating physical components of a computer used as part or all of the content sharing system and the client devices from FIG. 1, according to one embodiment.

FIG. 5 is an illustration of inferring of demographic attributes of users based on the method disclosed in FIG. 3, according to one embodiment.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

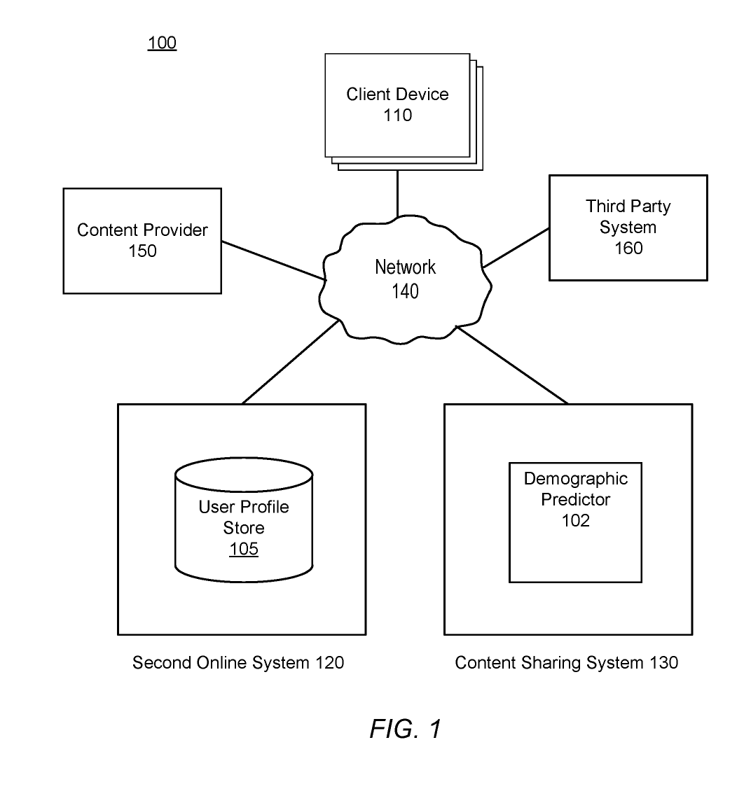

FIG. 1 illustrates a computing environment 100 in which users use the client devices 110 to interact with a content sharing system 130 via a network 140, according to one embodiment. The environment also includes a second online system 120 storing user profiles against which the content sharing system 130 may match profiles of users of the content sharing system to obtain additional user attributes. In alternative configurations, different and/or additional components may be included in the computing environment 100. For example, in some embodiments, the computing environment 100 includes one or more third-party systems 160 and one or more content providers 150. The embodiments described herein can be adapted to online systems that are not social networking systems.

The client devices 110 are one or more computing devices capable of receiving user input as well as transmitting and/or receiving data via the network 140. The client devices 110 are configured to communicate via the network 140, which may comprise any combination of local area and/or wide area networks, using both wired and/or wireless communication systems.

The second online system 120 represents a system that can communicate with the client devices 110 via the network 140. In some embodiments, the second online system 120 represents a social networking system including users with various demographic attributes.

The second online system 120 includes a user profile store 105. Each user of the second online system 120 is associated with a user profile, which is stored in the user profile store 105. A user profile includes declarative information about the user that was explicitly shared by the user or inferred by the second online system. In one embodiment, a user profile includes multiple data fields, each describing one or more attributes of the corresponding user of the second online system 120. Examples of information stored in a user profile include biographic, demographic, and other types of descriptive information, such as age, gender, work experience, educational history, hobbies or preferences, location and the like. Examples of demographic attributes analyzed in different embodiments include age, gender, geographic location, and income, and in some embodiments, may also include information about user interests, such as whether the user is interested in video games, in travel, in gardening, in a particular movie, and the like.

The content sharing system 130 (also referred to as the “first online system”) represents a system for sharing content items to users in a unidirectional fashion through the network 140. The content sharing system 130 represents relationships between users with unidirectional connection between the users. For example, the content sharing system 130 may share images or videos posted by a first user to a set of other users having a unidirectional connection with the first user. In some embodiments, the content sharing system 130 maintains at least “follower of” and “followed by” information about its users. For example, the “follower of” information for a user includes a set of nodes in a social graph corresponding to users that have a unidirectional connection with the user (e.g., for a first user, Chris, the set of users Bob, Paul, and John, each of whom Chris follows within the content sharing system 130). In the same example, the “followed by” information for a user includes a set of nodes in the social graph corresponding to users that have a unidirectional connection in the other direction (e.g., for the user Chris, the set of users Brian and Mike, both of whom follow Chris).

The content sharing system 130 may distribute content items to the client devices 110 based on the targeting criteria for the users with specific demographic attributes, provided that those demographic attributes are known. The content items distributed by the content sharing system 130 may include, but not restricted to, sponsored content items (e.g. advertisements).

However, in many cases, the content sharing system 130 either does not itself track values of the demographic attributes specified in the targeting criteria, or those demographic attributes (even if tracked by the content sharing system) are not known for a given user.

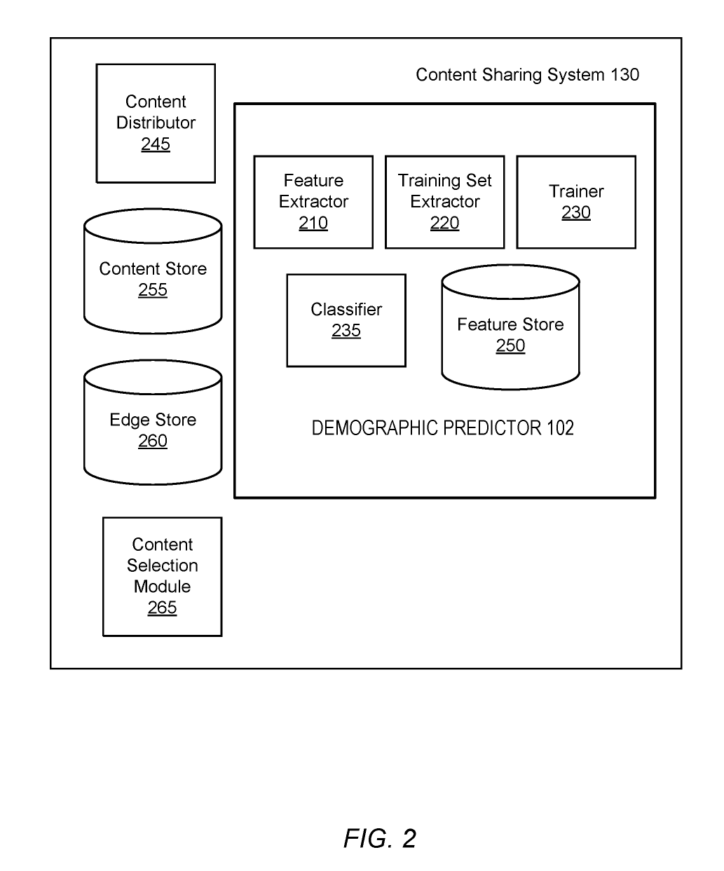

To address this situation, the content sharing system 130 comprises a demographic predictor 102 that infers the demographic attributes of the users that have missing information about their demographic attributes. The demographic predictor 102 can infer the demographic attributes based on features about the users, as described below with reference to FIG. 2.

The content provider 150 may be coupled to the network 140 for communicating with the second online system 120. In one embodiment, the content provider 150 provides content items to share with the client device 110 through the content sharing system 130. For example, the content provider 150 might provide a promotional content item to the content sharing system 130 and the content sharing system 130 might present the promotional content item to a user associated with the client device 110.

One or more third party systems 160 may be coupled to the network 140 for communicating with the second online system 120. In one embodiment, a third party system 160 is an application provider communicating information describing applications for execution by a client device 110 or communicating data to client devices 110 for use by an application executing on the client device, such as a web site that provides (for example) news. In other embodiments, a third party system 160 provides content or other information for presentation via a client device 110. A third party system 160 may also communicate information to the content sharing system 130, such as sponsored content items, content, or information about an application provided by the third party system 160.

FIG. 1 is only one example of the computing environment to share device level features through the network 140. In one embodiment, a client device 110 may be a device having computer functionality, such as a personal digital assistant (PDA), a mobile telephone, a smartphone or another suitable device. In one embodiment, the client devices 110 execute an application allowing a user of the client devices 110 to interact with the content sharing system 130. For example, the client devices 110 execute a browser application to enable interaction between the client devices 110 and the content sharing system 130 via the network 140. In another embodiment, the client devices 110 interact with the content sharing system 130 through an application programming interface (API) running on a native operating system of the client devices 110, such as IOS® or ANDROID™. In alternate configurations, the computing environment may include multiple content sharing system 130, or the content sharing system 130 may include additional, fewer, or different components for various applications. In one embodiment, the network 140 uses standard communications technologies and/or protocols. Data exchanged over the network 140 may be represented using any suitable format, such as hypertext markup language (HTML) or extensible markup language (XML). In some embodiments, all or some of the communication links of the network 140 may be encrypted using any suitable technique or techniques. Conventional components such as network interfaces, security functions, load balancers, failover servers, management and network operations consoles, and the like are not shown so as to not obscure the details of the computing environment.

FIG. 2 is a high-level block diagram illustrating a detailed view of the content sharing system 130 for inferring demographic attributes of users, according to one embodiment. The second online system 120 includes the demographic predictor 102, a content distributor 245, a content store 255, an optional edge store 260, and a content selection module 265.

The demographic predictor 102 is a module of the content sharing system 130 that can predict or infer the demographic attributes (e.g. age, gender, geographic location, etc.) of a user. The demographic predictor 102 includes a feature extractor 210, a training set extractor 220, a trainer 230, a classifier 235, and a feature store 250.

The feature extractor 210 is a module that extracts features associated with users that can be used for machine learning purposes. For instance, the extracted features may include one or more distributions of attributes (e.g., an age, a gender, and a geographic location) of users connected in a unidirectional following relationship in a social graph. As described below, the content sharing system 130 may not itself track one or more of the attributes whose values are to be extracted as features. In such a case, the content sharing system matches profiles of the users who are connected in the unidirectional relationships to profiles of users on a second second online system 120 that tracks the attributes in question for the users, such as a social networking system. The users whose profiles can be matched to profiles on the second online system 120 then have values of the attributes determined based on the profiles on the second online system; users whose profiles cannot be so matched do not contribute attributes to the set of features.

The training set extractor 220 identifies a training set of the overall data set that is representative of the data that the content sharing system 130 classifies. More specifically, the training set extractor 220 identifies, for each demographic attribute to be assessed, users of the content sharing system 130 for whom the desired labels (i.e. the demographic attributes) can already be determined. For example, for the “female” demographic attribute, the training set extractor 220 extracts a positive training set comprising a set of users for whom the gender attribute is known to be female. In another example, for an “is age 13-15” attribute, the training set extractor 220 identifies positive training set comprising users known to be in the age range of 13-15.

In embodiments in which the content sharing system 130 does not itself track the demographic attribute in question (e.g., gender, or age range), the content sharing system attempts to determine values of the attribute for users of the content sharing system by matching profiles of those users on the content sharing system with profiles on a second online system 120 that has the attributes in question, such as a social networking system. (Cookie syncing may be used to establish mapping between profiles of users on the two systems—the content sharing system 130, and the second online system 120.) Users whose profiles can be matched to profiles on the second online system 120, and who have a particular value of the demographic attribute in question (e.g., “female”), constitute the training set of users for that demographic attribute value.

In some embodiments, the training set extractor 220 compares the training set with data from a third party data tracking system (e.g. Nielsen data) to verify that the training set is accurate. For example, the training set extractor 220 confirms that the user correctly reported the age, gender, and other demographic attributes in the user profile by comparing the user profile data with the data stored by the third party tracking system. The training set extractor 220 filters out data with low confidence from the training set to increase the accuracy of the training set. In one embodiment, the content sharing system 130 partitions the training sets for the various attributes in order to produce a number of sub-sets of the training sets. For instance, the training sets could be clustered to produce sub-sets of users that are similar to each other according to some similarity metric. The content sharing system 130 runs a test campaign on the third party tracking system for the users of the sub-sets, indicating to the third-party tracking system that the target is the particular attribute values defining the training sets from which the sub-sets were drawn. (E.g., if a sub-set was drawn from a “males aged 18-24” set, the campaign indicates that it's targeted to males aged 18-24.) The content sharing system 130 accordingly obtains from the accuracy measurements from the third-party tracking system for the various sub-sets, indicating how accurate the targeting was (e.g., that 98% of the users of the “males aged 18-24” set were in fact males aged 18-24). Based on the accuracy measurements, the content sharing system 130 removes from the training sets the users of the sub-sets with sufficiently low accuracy measurements (e.g., below a fixed accuracy threshold, or some amount of the lowest accuracy measurements).

The trainer 230 derives a classifier 235 for each attribute for which the training set extractor 220 identified a training set. The demographic predictor 102 uses the classifier 235 to predict a value of the demographic attribute for which the classifier was trained (e.g., gender). The trainer 230 trains the classifier based on information about the known users of the second online system 120, as extracted by the feature extractor 210.

The trainer 230 provides the extracted features from the feature extractor 210 as an input to a training algorithm. The trainer 230 may be based on one or more training algorithms including, but not restricted to, regression algorithms, instance-based algorithms, regularization algorithms, decision tree algorithms, Bayesian algorithms, clustering algorithms, dimensionality reduction algorithms, or any combination thereof. In one example, the trainer 230 uses a linear Support Vector Machine (SVM) algorithm. In some embodiments, the trainer 230 selects the training algorithm based on the size of the training set.

The trainer 230 trains the classifier 235 generated from the training set formed by the training set extractor 220. The classifier 235, when applied to features corresponding to a user (or a client device 110 of the user) outputs a prediction of a value for at least one of the demographic attributes of the user. For example, the classifier 235 might output a prediction that a particular user is a female user in the age range of 18 to 20.

The content distributor 245 selects content to provide to the user based on the demographic attribute value prediction by the classifier 235. For example, the content distributor 245 might select a particular shared content item to provide to the user when the classifier 235 outputs a predicted value of demographic attributes that matches with the audience targeted by the provider of such shared content item (e.g., predicting that the user is 28, where the provider of the shared content item specified that the appropriate audience includes users aged 20-30). That is, the content sharing system 130 uses the classifier 235 generated by the trainer 230 to infer demographic attribute information for users. The content distributor 245 uses the inferred demographic attribute information to target the audience for the shared content by providing the shared content that matches the demographic profiles with inferred attributes. For example, if the predictor 102 inferred that a particular user is female, the content distributor 245 could use that inference to determine that it should provide content that females would tend to like.

Different types of content may be provided by the content distributor 245 in different embodiments. In one embodiment, the content is an advertisement appropriate for the inferred attributes. In other embodiments, the content is a news story.

The feature store 250 stores the features associated with users extracted by the feature extractor 210. In some embodiments, the feature store 250 may represent a repository of demographic information and data (e.g. distribution graph) about a set of users that an user follows or is followed upon. For example, the feature store 250 may store the values of age and gender distribution of users that follow the user.

The content store 255 stores objects that each represent various types of content. Examples of content represented by an object include a page post, a status update, a photograph, a video, a link, a shared content item, a gaming application achievement, a check-in event at a local business, a brand page, or any other type of content. Content sharing system users may create objects stored by the content store 255, such as status updates, photos tagged by users to be associated with other objects in the content sharing systems 130, events, groups or applications. In some embodiments, objects are received from third-party applications or third-party applications separate from the content sharing systems 130. In one embodiment, objects in the content store 255 represent single pieces of content, or content “items.” Hence, content sharing system users are encouraged to communicate with each other by posting text and content items of various types of media to the content sharing systems 130 through various communication channels. This increases the amount of interaction of users with each other and increases the frequency with which users interact within the content sharing systems 130.

One or more content items included in the content store 255 include content for presentation to a user and a bid amount for the content. The content is text, image, audio, video, or any other suitable data presented to a user. In various embodiments, the content also specifies a page of content. For example, a content item includes a landing page specifying a network address of a page of content to which a user is directed when the content item is accessed. The bid amount is included along with the content item by a user and is used to determine an expected value, such as monetary compensation, provided by an advertiser to the content sharing systems 130 if content in the content item is presented to a user, if the content in the content item receives a user interaction when presented, or if any suitable condition is satisfied when content in the content item is presented to a user. For example, the bid amount included in a content item specifies a monetary amount that the content sharing systems 130 receives from a user who provided the content item to the content sharing systems 130 if content in the content item is displayed. In some embodiments, the expected value to the content sharing systems 130 of presenting the content from the content item may be determined by multiplying the bid amount by a probability of the content of the content item being accessed by a user.

In various embodiments, a content item includes various components capable of being identified and retrieved by the content sharing systems 130. Example components of a content item include: a title, text data, image data, audio data, video data, a landing page, a user associated with the content item, or any other suitable information. The content sharing systems 130 may retrieve one or more specific components of a content item for presentation in some embodiments. For example, the content sharing systems 130 may identify a title and an image from a content item and provide the title and the image for presentation rather than the content item in its entirety.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to content sharing system users, the content sharing systems 130 logs interactions between users presented with the content item or with objects associated with the content item. Additionally, the content sharing systems 130 receives compensation from a user associated with content item as online system users perform interactions with a content item that satisfy the objective included in the content item.

Additionally, a content item may include one or more targeting criteria specified by the user who provided the content item to the content sharing systems 130. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In various embodiments, the content store 255 includes multiple campaigns, which each include one or more content items. In various embodiments, a campaign in associated with one or more characteristics that are attributed to each content item of the campaign. For example, a bid amount associated with a campaign is associated with each content item of the campaign. Similarly, an objective associated with a campaign is associated with each content item of the campaign. In various embodiments, a user providing content items to the content sharing systems 130 provides the content sharing systems 130 with various campaigns each including content items having different characteristics (e.g., associated with different content, including different types of content for presentation), and the campaigns are stored in the content store.

In one embodiment, targeting criteria may specify actions or types of connections between a user and another user or object of the content sharing systems 130. Targeting criteria may also specify interactions between a user and objects performed external to the content sharing systems 130, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the content sharing system 130, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

In some embodiments, the edge store 260 also stores information about edges, such as affinity scores for objects, interests, and other users. Affinity scores, or “affinities,” may be computed by the content sharing systems 130 over time to approximate a user's interest in an object or in another user in the content sharing systems 130 based on the actions performed by the user. A user's affinity may be computed by the content sharing systems 130 over time to approximate the user's interest in an object, in a topic, or in another user in the content sharing systems 130 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 260, in one embodiment. Alternatively, each interaction between a user and a specific object is stored as a separate edge.

The edge store 260 also stores information about edges corresponding to content sharing systems 130 that has a unidirectional connection between the users. For example, the edge store 260 includes a first type of affinity score for users that follow other users and a second type of affinity score for users that are followed by a specific user. In alternate embodiments, the edge store 260 also includes a weighted affinity score that has individual weights assigned by the content sharing systems 130 corresponding to the strength of each of the unidirectional connection between its users.

The edge store 260 also stores information indicating the unidirectional connection between the users of the content sharing systems 130. In some embodiments, the edge store 260 stores only positive values of affinity scores indicating the unidirectional connection between its users. For example, an affinity score of +0.5 indicates the strength of connection in a forward direction whereas an affinity score of −0.5 indicates the strength of connection in a reverse direction.

The content selection module 265 selects one or more content items for communication to a client device 110 to be presented based on the predicted values of the demographic attributes of the user. Content items eligible for presentation to the user are retrieved from the content store 255 or from another source by the content selection module 265, which selects one or more of the content items for presentation to the viewing user. In various embodiments, the content selection module 265 includes content items eligible for presentation to the user in one or more selection processes, which identify a set of content items for presentation to the user. For example, the content selection module 265 determines measures of relevance of various content items to the user based on characteristics associated with the user by the content sharing systems 130 and based on the user's affinity for different content items. Based on the measures of relevance, the content selection module 265 selects content items for presentation to the user. As an additional example, the content selection module 265 selects content items having the highest measures of relevance or having at least a threshold measure of relevance for presentation to the user. Alternatively, the content selection module 265 ranks content items based on their associated measures of relevance and selects content items having the highest positions in the ranking or having at least a threshold position in the ranking for presentation to the user.

FIG. 2 is only an example of the predictor 102. In other configurations, for example, the predictor 102 may represent one or more modules in separate content sharing systems 130 that can communicate with each other through the network 140.

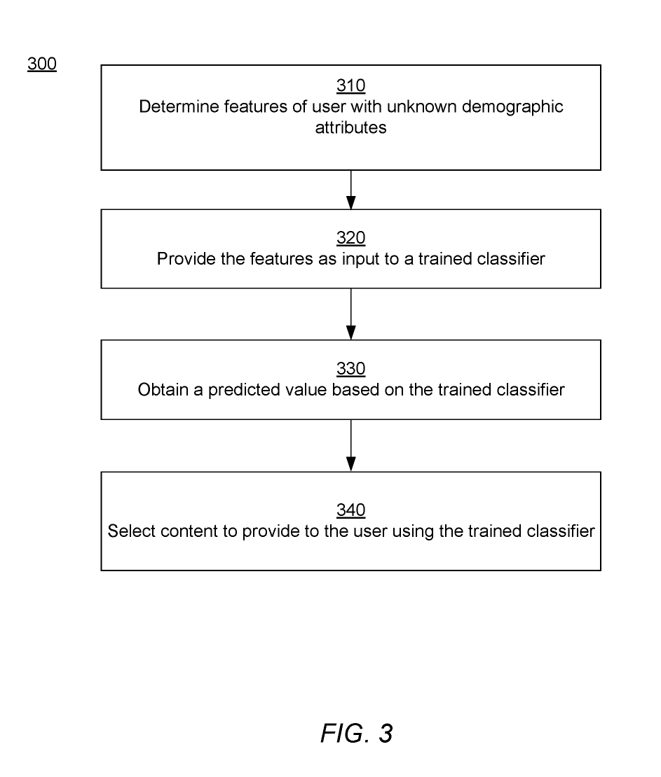

FIG. 3 is a flowchart illustrating the selection of content to provide to the user based on inferred demographic attributes, according to one embodiment.

The content sharing system 130 determines 310 features of a user of a social networking functionality with unidirectional connection for whom a value of one or more demographic attributes is not known (e.g., because the user is an user due to lack of login). For example, the first demographic attributes may represent age, gender, or physical location of the user. The determined features (e.g. distributions of demographic attributes, interests of users associated with the first online system, a set of users that the user follows) represent properties of the client devices 110 as extracted by the feature extractor 210 described above with reference to FIG. 2.

The content sharing system 130 provides 320 the features as input to a trained classifier 235 derived from machine learning by the trainer 230 using training algorithms such as linear Support Vector Machine (SVM), as described above with reference to FIG. 2 (the first embodiment predicting demographic attributes using device-level features).

The content sharing system 130 obtains 330 from the trained classifier 235 an output including the prediction of a value for at least one of the demographic attributes of the user.

The content sharing system 130 selects 340 content to provide to the user based on the predicted values of the demographic attributes of the user using the trained classifier. For example, the content distributor 245 provides an appropriate newsfeed item or other sponsored content to the user responsive to the user having the target criteria based on age or gender as described above with reference to FIG. 2.

It is appreciated that although FIG. 3 illustrates a number of steps according to one embodiment, the precise steps and/or order of steps may vary in different embodiments.

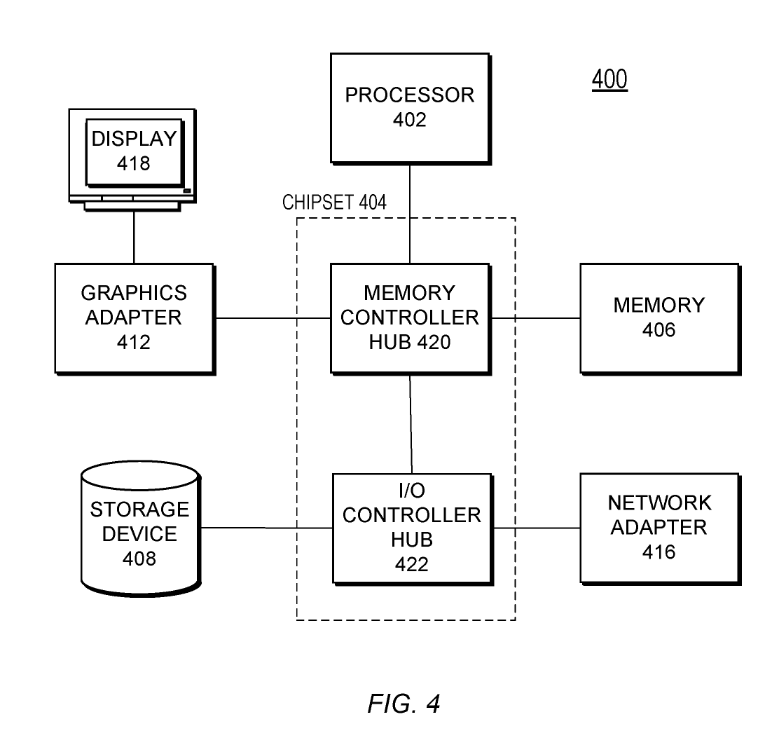

FIG. 4 is a high-level block diagram illustrating physical components of a computer used as part or all of the content sharing system and the client devices from FIG. 1, according to one embodiment. Illustrated are at least one processor 402 coupled to a chipset 404. Also coupled to the chipset 404 are a memory 406, a storage device 408, a graphics adapter 412, and a network adapter 416. A display 418 is coupled to the graphics adapter 412. In one embodiment, the functionality of the chipset 404 is provided by a memory controller hub 420 and an I/O controller hub 422. In another embodiment, the memory 406 is coupled directly to the processor 402 instead of the chipset 404.

The storage device 408 is any non-transitory computer-readable storage medium, such as a hard drive, compact disk read-only memory (CD-ROM), DVD, or a solid-state memory device. The memory 406 holds instructions and data used by the processor 402. The graphics adapter 412 displays images and other information on the display 418. The network adapter 416 couples the computer 400 to a local or wide area network.

As is known in the art, a computer 400 can have different and/or other components than those shown in FIG. 4. In addition, the computer 400 can lack certain illustrated components. In one embodiment, a computer 400 acting as a server may lack a graphics adapter 412, and/or display 418, as well as a keyboard or pointing device. Moreover, the storage device 408 can be local and/or remote from the computer 400 (such as embodied within a storage area network (SAN)).

As is known in the art, the computer 400 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 408, loaded into the memory 406, and executed by the processor 402.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

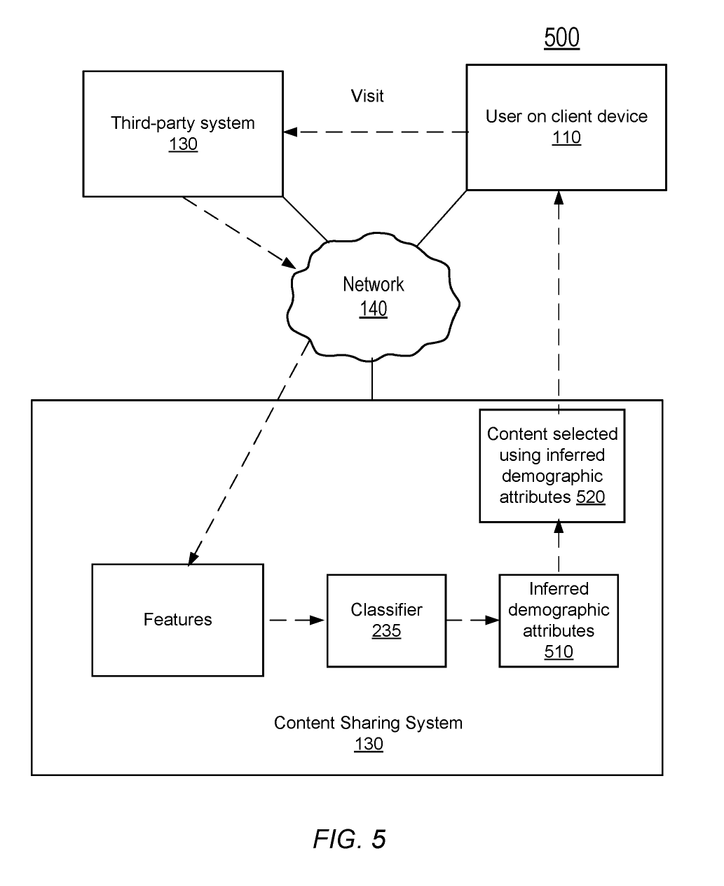

FIG. 5 illustrates the inferring of demographic attributes of users based on the method disclosed in FIG. 3, according to one embodiment. In FIG. 5, a user visits the third-party system 130 (a website, in this example) using the user's client device 110. In response to the visit by the user, the third-party system 130 transmits features to the content sharing system 130 via the network 140 (e.g., as part of a request for data from the content sharing system 130, as specified in a webpage of content from the third-party system 130). (As noted above, the features may be distributions of demographic attributes of users with a unidirectional connection, as determined by profile matching between the two systems—the content sharing system 130, and the second online system 120.) As described above in conjunction with FIG. 2-4 above, the content sharing system 130 inputs the features to the trained classifier 235. The trained classifier 235 outputs the values of inferred demographic attributes 510 (e.g., that the user is inferred to be age 28). The content sharing system 130 provides the content selected using inferred demographic attributes 520 to the user on the client device 110 (e.g., content provided earlier by the content provider 150 to the content sharing system 130 and specified to be targeted to users aged 20 to 30).

### Other Considerations

The present invention has been described in particular detail with respect to one possible embodiment. Those of skill in the art will appreciate that the invention may be practiced in other embodiments. First, the particular naming of the components and variables, capitalization of terms, the attributes, data structures, or any other programming or structural aspect is not mandatory or significant, and the mechanisms that implement the invention or its features may have different names, formats, or protocols. Also, the particular division of functionality between the various system components described herein is merely for purposes of example, and is not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of computer-readable storage medium suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A computer-implemented method performed by a first online system, the computer-implemented method comprising:
for a user of the first online system for whom the first online system does not have a first demographic attribute, determining features for the user based on matching a plurality of unidirectional connections of the user on the first online system with one or more user accounts on a second online system;
providing the features as input to a classifier derived from machine learning;
obtaining, as an output from the classifier, a prediction of a value for the first demographic attribute; and
selecting content to provide to the user based on whether the user has the predicted value of the first demographic attribute.

2. The method of claim 1, wherein the features for the user comprise attributes of a set of users on the first online system, the set of users comprising at least one of: users that the user follows on the first online system, and users that follow the user on the first online system.

3. The method of claim 2, wherein the features for the user include one or more distributions of at least one of: an age, a gender, and a geographic location of the set of users based on profiles of the set of users on the second online system.

4. The method of claim 2, wherein at least some of the users of the first online system do not have an online account on the second online system.

5. The method of claim 2, wherein the user is not logged in to the second online system.

6. The method of claim 2, further comprising training the classifier to predict the first demographic attribute, the training comprising:
forming a training set corresponding to users with a first value of the first demographic attribute in user profiles on the second online system;
for users of the training set, deriving features comprising distributions of demographic attributes of a second set of users with a unidirectional connection to the users on the first online system; and
providing the derived features as input to a machine learning algorithm.

7. The method of claim 2, further comprising training the classifier to predict the first demographic attribute, the training comprising:
forming a training set corresponding to users with a first value of the first demographic attribute;
for users of the training set, deriving features comprising interests a second set of users with a unidirectional connection to the users on the first online system; and
providing the derived features as input to a machine learning algorithm.

8. The method of claim 7, wherein the training further comprises filtering on at least some of the users of the first online system, the filtering performed responsive to the output not matching with information from a third-party tracking system.

9. A non-transitory computer-readable storage medium storing instructions that when executed by a processor of a first online system perform actions comprising:
for a user of the first online system for whom the first online system does not have a first demographic attribute, determining features for the user based on matching a plurality of unidirectional connections of the user on the first online system with one or more user accounts on a second online system;
providing the features as input to a classifier derived from machine learning;
obtaining, as an output from the classifier, a prediction of a value for the first demographic attribute; and
selecting content to provide to the user based on whether the user has the predicted value of the first demographic attribute.

10. The non-transitory computer-readable storage medium of claim 9, wherein the features for the user comprise attributes of a set of users on the second first online system, the set of users comprising at least one of: users that the user follows on the second first online system, and users that follow the user on the second first online system.

11. The non-transitory computer-readable storage medium of claim 9, wherein in the features for the user include one or more distributions of at least one of: an age, a gender, and a geographic location of the set of users based on profiles of the set of users on the second online system.

12. The non-transitory computer-readable storage medium of claim 9, wherein at least some of the users of the first online system do not have an online account on the second online system.

13. The non-transitory computer-readable storage medium of claim 9, wherein the user is not logged in to the second online system.

14. The non-transitory computer-readable storage medium of claim 9, the actions further comprising
training the classifier to predict the first demographic attribute, the training comprising:
forming a training set corresponding to users with a first value of the first demographic attribute in user profiles on the second online system;
for users of the training set, deriving features comprising distributions of demographic attributes of a second set of users with a unidirectional connection to the users on the first online system; and
providing the derived features as input to a machine learning algorithm.

15. The non-transitory computer-readable storage medium of claim 9, the actions further comprising training the classifier to predict the first demographic attribute, the training comprising:
forming a training set corresponding to users with a first value of the first demographic attribute;
for users of the training set, deriving features comprising interests a second set of users with a unidirectional connection to the users on the first online system; and
providing the derived features as input to a machine learning algorithm.

16. The non-transitory computer-readable storage medium of claim 15, wherein the training further comprises a filtering on at least some of the users of the first online system, the filtering performed responsive to the output not matching with information from a third-party tracking system.

17. A first online system comprising:
a computer processor; and
a non-transitory computer-readable storage medium storing instructions that when executed by the computer processor perform actions comprising:
for a user of the first online system for whom the first online system does not have a first demographic attribute, determining features for the user based on matching a plurality of unidirectional connections of the user on the first online system with one or more user accounts on a second online system;
providing the features as input to a classifier derived from machine learning;
obtaining, as an output from the classifier, a prediction of a value for the first demographic attribute; and
selecting content to provide to the user based on whether the user has the predicted value of the first demographic attribute.

18. The computer system of claim 17, wherein the features for the user comprise attributes of a set of users on the first online system, the set of users comprising at least one of:
users that the user follows on the first online system, and users that follow the user on the first online system.

19. The computer system of claim 17, wherein the features for the user include one or more distributions of at least one of: an age, a gender, and a geographic location of the set of users based on profiles of the set of users on the second online system.

20. The computer system of claim 17, wherein at least some of the users of the first online system do not have an online account on the second online system.
